(19) United States
(12) Patent Application Publication
(10) Pub. No.: US 2009/0053597 A1
(43) Pub. Date: Feb. 26, 2009

(54) ELECTROLYTE COMPOSITION USED IN CHARGE STORAGE DEVICE AND STORAGE DEVICE USING THE SAME

(76) Inventors: Katsuhiko Tsunashima, Tokyo (JP); Fumihiro Yonekawa, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 12/195,121

(22) Filed: Aug. 20, 2008

(30) Foreign Application Priority Data
Aug. 23, 2007 (JP) 2007-217127

(51) Int. Cl. H01M 6/04

(52) U.S. Cl. 429/188

(57) ABSTRACT

The present invention provides an electrolyte composition used in a charge storage device, which comprises an ionic liquid that has high ionic conductivity and is highly safe with no risks of inflammation and the like. It is an electrolyte composition used in a charge storage device, which comprises a quaternary phosphonium salt ionic liquid represented by general formula (1) as described below. The viscosity at 25° C. of this ionic liquid is preferably 200 mPa·sec or less. In the general formula (1), it is preferable that the alkoxyalkyl group be a methoxymethyl group and that all the alkyl groups be ethyl groups.

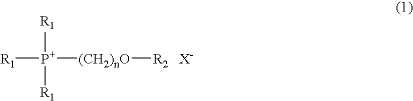

wherein R₁ represents a linear or branched alkyl group containing 1 to 3 carbon atoms; R₂ represents a methyl group or an ethyl group; n represents an integer between 1 and 3; and X represents N(SO₂CF₃)₂.

### BACKGROUND OF THE INVENTION

1. Field of the Invention

The present invention relates to an electrolyte composition used in a charge storage device, which comprises a quaternary phosphonium salt ionic liquid, and a charge storage device using the same.

2. Description of the Related Art

A lithium secondary battery has a high energy density and is excellent in terms of cycle characteristics. Thus, such a lithium secondary battery has already been widely used as a power supply of portable electronic products. In addition, such a lithium secondary battery has also been used in products that require high capacity and high power, such as electric cars or hybrid cars. For such a lithium secondary battery, an organic solvent such as ethylene carbonate, dimethyl carbonate, diethyl carbonate or ethyl methyl carbonate is generally used as an electrolyte solution. Thus, problems such as inflammation and/or explosion due to the breakage of a battery case or a short circuit in the battery, environmental contamination due to the leakage of an electrolyte solution, etc. have been pointed out. As a measure for solving such problems, use of a solid polymer electrolyte has been studied. However, to date, a solid polymer electrolyte exhibiting sufficient ionic conductivity even at a low temperature has not yet been discovered.

As an electrolyte solution used in a lithium secondary battery substituted for the aforementioned organic electrolyte solution, a method using an ionic liquid (an ambient temperature molten salt) that is a nonvolatile and nonflammable substance has been proposed. As such ionic liquids, compounds having a nitrogen cation, such as an imidazolium salt, a pyridinium salt, a quaternary ammonium salt, a pyrrolidinium salt and a piperidinium salt are mainly used (Japanese Patent Laid-Open No. 2004-43407, Japanese Patent Laid-Open No. 2004-123631, Japanese Patent Laid-Open No. 2004-146346, Japanese Patent Laid-Open No. 2006-36652, and Japanese Patent Laid-Open No. 2007-109591, for example). It has been known that, among these ionic liquids, an imidazolium salt and a pyridinium salt have a low viscosity and high ionic conductivity, but that they are easily reduced because they are aromatic compounds, so that they are poor in terms of a withstand voltage property. On the other hand, onium salts such as a quaternary ammonium salt, a pyrrolidinium salt and a piperidinium salt have a wide potential window and are excellent in terms of a withstand voltage property. However, such onium salts have a relatively high viscosity and thus, ionic conductivity tends to become low. Moreover, even in the case of an ionic liquid, which is considered to be nonflammable, if it is exposed to an extremely high temperature, it generates pyrolytically-generated products. It cannot be denied that such pyrolytically-generated products are ignited and as a result, they begin to burn.

On the other hand, an ionic liquid mainly comprising a quaternary phosphonium cation that is a phosphorous onium salt has also been known. Such a quaternary phosphonium salt has been known to be chemically and thermally stable, and has also been known to have nonflammability (self-extinguishing property). With regard to application of a quaternary phosphonium salt ionic liquid to the electrolyte solution of a lithium secondary battery, Japanese Patent Laid-Open No. 2004-43407 and Japanese Patent Laid-Open No. 2004-146346 describe an electrolyte composition comprising a quaternary ammonium salt and a phosphonium salt containing an alkyl group bound to a nitrogen atom or a phosphorus atom, for example. Moreover, International Publication WO02/076924 describes triethyl(2-methoxyethyl)phosphonium tetrafluoroborate as a quaternary phosphonium salt. All such quaternary phosphonium salt ionic liquids described in the aforementioned documents have a high viscosity, and thus they have not yet overcome various problems of lithium secondary batteries.

It is an object of the present invention to provide an electrolyte composition used in a charge storage device, which is capable of overcoming various disadvantages of the aforementioned prior art techniques, and a charge storage device using the same.

### SUMMARY OF THE INVENTION

Under such circumstances, as a result of intensive studies, the present inventors have found that an ionic liquid comprising a specific quaternary phosphonium salt has a significantly low viscosity and high ionic conductivity and is excellent in terms of a withstand voltage property, heat resistance and nonflammability, and thus that such an ionic liquid can be used in the electrolyte composition of a charge storage device, thereby completing the present invention.

That is to say, the present invention provides an electrolyte composition used in a charge storage device, which comprises a quaternary phosphonium salt ionic liquid represented by the following general formula (1), thereby achieving the aforementioned object:

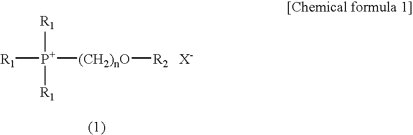

wherein R₁ represents a linear or branched alkyl group containing 1 to 3 carbon atoms; R₂ represents a methyl group or an ethyl group; n represents an integer between 1 and 3; and X represents N(SO₂CF₃)₂.

Moreover, the present invention also provides a charge storage device such as a lithium secondary battery, an electric double layer capacitor or a lithium ion capacitor, which comprises the aforementioned electrolyte composition as an electrolyte.

The quaternary phosphonium salt ionic liquid contained in the electrolyte composition of the present invention used in a charge storage device has a low viscosity. Thus, since the electrolyte composition of the present invention comprising the ionic liquid has a low viscosity, it has high ionic conductivity. Using this electrolyte composition for a charge storage device such as a lithium secondary battery, an electric double layer capacitor or a lithium ion capacitor, high charge-discharge characteristics can be achieved. Furthermore, a withstand voltage property, heat resistance and nonflammability can also be increased.

### DETAILED DESCRIPTION OF THE PREFERRED EMBODIMENTS

The present invention will be described below based on preferred embodiments. The present invention relates to an electrolyte composition used in a charge storage device, which comprises a quaternary phosphonium salt ionic liquid represented by the aforementioned general formula (1). Three out of four groups of the quaternary phosphonium salt represented by the general formula (1) are the same short chain alkyl groups represented by R₁, and the remaining one group is an alkoxyalkyl group represented by —(CH₂)ₙO—R₂. A quaternary phosphonium salt having such a structure has a viscosity significantly lower than that of a quaternary phosphonium salt wherein groups bound to phosphorus are all alkyl groups. The reason for the fact that the quaternary phosphonium salt represented by the general formula (1) has a significantly low viscosity has not been completely clarified. It is considered that the electron-donating property of an alkoxy group weakens cationic charge. In addition, the withstand voltage property and heat resistance of an electrolyte composition are improved by the condition wherein the three groups are all the same alkyl groups.

R₁ in the general formula (1) is a short chain alkyl group. Specific examples of such a short chain alkyl group include a methyl group, an ethyl group, an n-propyl group, and an i-propyl group. Among these groups, a methyl group or an ethyl group is particularly preferable from the viewpoint of a decrease in the viscosity of the quaternary phosphonium salt ionic liquid and a reduction in the content of halogen as a substance causing a decrease in the performance of a charge storage device.

Specific examples of the alkoxyalkyl group represented by —(CH₂)ₙO—R₂ in the general formula (1) include a methoxymethyl group, a 2-methoxyethyl group, a 3-methoxypropyl group, an ethoxymethyl group, a 2-ethoxyethyl group, and a 3-ethoxypropyl group. Among these alkoxyalkyl groups, those having 1 or 2 carbon atoms in an alkylene portion thereof, and in particular, those having 2 carbon atoms in an alkylene portion thereof are preferable in that they are able to increase the withstand voltage property of an electrolyte composition.

As an anionic component of X in the general formula (1), bis(trifluoromethylsulfonyl)imide (N(SO₂CF₃)₂) is used. As a result of the studies conducted by the present inventors, it was revealed that the withstand voltage property and heat resistance of an electrolyte composition are extremely improved by combining this anionic component with the aforementioned phosphonium cationic component.

Specific examples of the quaternary phosphonium salt represented by the general formula (1) include triethyl(methoxymethyl)phosphonium bis(trifluoromethylsulfonyl)imide, triethyl(2-methoxyethyl)phosphonium bis(trifluoromethylsulfonyl)imide, tri-n-propyl(methoxymethyl)phosphonium bis(trifluoromethylsulfonyl)imide, and tri-n-propyl(2-methoxyethyl)phosphonium bis(trifluoromethylsulfonyl)imide. Among these compounds, triethyl(methoxymethyl)phosphonium bis(trifluoromethylsulfonyl)imide, triethyl(2-methoxyethyl)phosphonium bis(trifluoromethylsulfonyl)imide, and the like are particularly preferable in that they exhibit a low viscosity, a withstand voltage property and heat resistance.

The quaternary phosphonium salt represented by the general formula (1) is a liquid form having ionic conductivity at room temperature (25° C.), namely, an ionic liquid. This quaternary phosphonium salt ionic liquid has a viscosity at 25° C. of 200 mPa·sec or less, preferably 100 mPa·sec or less, and more preferably 50 mPa·sec or less. By setting such a viscosity at 200 mPa·sec or less, the purification efficiency of the ionic liquid is increased, so that an electrolyte composition with a small content of impurities can be favorably obtained. The lower limit of the viscosity of the ionic liquid comprising the quaternary phosphonium salt is not particularly limited. The lower the viscosity of the ionic liquid, the more preferable. If the viscosity at 25° C. is sufficiently low (approximately 20 mPa·sec), the ionic conductivity becomes sufficiently high. Thus, the charge-discharge characteristics of a charge storage device in which the electrolyte composition is used tends to increase. Accordingly, it is preferable that the aforementioned ionic liquid have a low viscosity.

The quaternary phosphonium salt represented by the general formula (1) can be obtained by allowing a quaternary phosphonium halide to react with the metal salt of an anionic component to conduct anion exchange. Such a quaternary phosphonium halide is a generic name for the quaternary phosphonium salt represented by the general formula (1), wherein the anionic portion is halogen.

When such a quaternary phosphonium halide is a trialkyl(alkoxyalkyl)phosphonium halide, this compound can be obtained by allowing trialkylphosphine to react with halogenated alkoxyalkyl, for example. In particular, a method comprising allowing trialkylphosphine (general formula: (Ra)₃P) wherein three groups bound to a phosphorus atom are the same types of alkyl groups to react with halogenated alkoxyalkyl (general formula: X—(CH₂)ₙO—R_{b}) is preferably adopted because a product of interest with a small amount of impurities can be obtained by such a method. Moreover, the halogen of the quaternary phosphonium halide is preferably bromine or iodine because the quaternary phosphonium halide can be purified by recrystallization. From this viewpoint, alkoxyalkyl bromide or alkoxyalkyl iodide is preferably used as halogenated alkoxyalkyl. When the halogen of the quaternary phosphonium halide is an element other than bromine or iodine, even if it is a chloride or the like, for example, such chlorine can be substituted with iodine or bromine, using sodium iodide or the like.

When the quaternary phosphonium halide is a trialkyl(alkoxyalkyl)phosphonium halide, in order to generate such a compound, halogenated alkoxyalkyl is added to trialkylphosphine at a molar ratio of preferably 0.5:1 to 2:1, and more preferably 0.9:1 to 1.2:1. Thereafter, the mixture is reacted in an inactive solvent that does not contain chlorine, such as in toluene, at a temperature between 20° C. and 150° C., and more preferably between 30° C. and 100° C., preferably for 3 hours or longer, and more preferably for 5 to 12 hours. As a reaction atmosphere, an atmosphere wherein no oxygen exists is preferable. For example, a nitrogen atmosphere or an argon atmosphere is preferable. If trialkylphosphine is allowed to react with halogenated alkoxyalkyl in an atmosphere wherein oxygen exists, a trialkylphosphine oxide is generated as a result that oxygen has bound to the trialkylphosphine, and the yield is thereby decreased. At the same time, the charge-discharge characteristics of a charge storage device in which an electrolyte composition comprising the trialkylphosphine oxide is used tends to be impaired. Such a trialkylphosphine oxide can be removed by washing with an organic solvent, as appropriate. However, if the total number of carbon atoms of the quaternary phosphonium halide increases, the quaternary phosphonium halide itself is also likely to be dissolved in such an organic solvent. Thus, it becomes difficult to remove the trialkylphosphine oxide. Further, a trialkylphosphine oxide containing 4 or more carbon atoms has a high affinity for the quaternary phosphonium salt ionic liquid used in the present invention, and thus it is likely that such a trialkylphosphine oxide is not easily removed by washing with pure water or an organic solvent. Accordingly, in order to prevent generation of such a trialkylphosphine oxide, it is preferable that the reaction be carried out in an inert atmosphere.

As a metal salt of an anionic component used in introduction of another anion into a quaternary phosphonium halide for anion exchange, an alkali metal salt such as the Li salt of the aforementioned anionic component can be used, for example. If such an alkali metal salt is used, halogenated alkali generated as a result of the reaction of the salt with a quaternary phosphonium halide can be easily removed by washing with water or using an adsorbent. Thus, the use of such an alkali metal salt is preferable.

Since halogenated alkali or unreacted halogenated alkali may decrease the performance of a charge storage device, it is necessary to decrease the amount of the remaining halogenated alkali to the minimum. In the case of an alkoxyalkyl group-substituted ionic liquid containing an alkyl group having 4 or more carbon atoms, it is likely to become difficult to remove halogen. However, since the quaternary phosphonium salt ionic liquid used in the present invention has a short alkyl group (containing 1 to 3 carbon atoms), the content of halogen can be set at 100 ppm or less, and preferably 50 ppm or less. Thereby, a decrease in the performance of a charge storage device can be suppressed.

As water used in washing, ultrapure water or deionized water can be used. Such water washing is preferably repeated, as appropriate, until the content of impurities is decreased. Impurities to be removed by water washing include unreacted materials, halogenated alkali, etc. Use of an adsorbent enables an efficient removal of halogenated alkali. In addition, in order to remove unreacted materials, by-products, and others, washing with an organic solvent can also be carried out, as appropriate. Preferred organic solvents that can be used in washing include nonpolar solvents that do not contain chlorine, such as pentane, hexane, or heptane. Using these nonpolar solvents, nonpolar organic compounds such as impurities can be efficiently removed without dissolution of a quaternary phosphonium salt.

The quaternary phosphonium salt washed with water or an organic solvent is preferably purified, so as to remove the water contents or organic solvent therefrom. Purification methods include dehydration with a molecular sieve, the removal of solvents by vacuum drying, etc. Purification by vacuum drying is preferable in that the mixing of impurities is prevented and in that water contents and organic solvents can be removed at once. In such purification by vacuum drying, the drying temperature is preferably between 70° C. and 120° C., and more preferably between 80° C. and 100° C. The degree of vacuum is preferably 0.1 to 1.0 kPa, and more preferably 0.1 to 0.5 kPa. The drying time is preferably for approximately 2 to 8 hours, and more preferably for approximately 5 to 12 hours.

The thus obtained ionic liquid comprising the quaternary phosphonium salt represented by the general formula (1) has properties such as a low viscosity caused by an alkoxyalkyl group, high ionic conductivity, moderate solubility, chemical stability, a withstand voltage property and heat stability, and thus it can preferably be used as an electrolyte of charge storage devices such as a lithium secondary battery, an electric double layer capacitor and a lithium ion capacitor. When the ionic liquid has a low viscosity, it is advantageous not only in that diffusion or convection is promoted to significantly improve ionic conductivity, but also in that since a viscosity-increasing degree due to cooling is also low, such ionic liquid can be used at a low temperature. Moreover, introduction of an alkoxyalkyl group tends to improve the solubility of an organic compound. That is, a molecular weight is decreased by shortening the size of an alkyl group, so as to obtain an ionic liquid with a low viscosity. At the same time, such introduction of an alkoxyalkyl group is able to solve the problem that the solubility of an organic compound additive is decreased by shortening the size of an alkyl group.

Furthermore, organic phosphorus compounds including the quaternary phosphonium salt represented by the general formula (1) as a typical example exhibit nonflammability and a self-extinguishing property. The ionic liquid comprising the quaternary phosphonium salt represented by the general formula (1) has a short alkyl group (containing 1 to 3 carbon atoms), and its molecular weight is small. Thus, the ratio of phosphorus atoms is high, and it has moderate nonflammability and a self-extinguishing property. Accordingly, the ionic liquid can be used as a nonflammable electrolyte of various charge storage devices.

As described above, since the ionic liquid comprising the quaternary phosphonium salt represented by the general formula (1) has a low viscosity, it has high ionic conductivity. As a result, high charge-discharge characteristics can be obtained, and a withstand voltage property and heat resistance are also high. Accordingly, it is clear that the ionic liquid can be used as an electrolyte composition of charge storage devices.

An electrolyte composition comprising the ionic liquid containing the quaternary phosphonium salt represented by the general formula (1) can preferably be used in charge storage devices such as a lithium secondary battery. This electrolyte composition does not contain a nonaqueous solvent. In general, an electrolyte solution that does not contain a nonaqueous solvent tends to have electric conductivity lower than that of an electrolyte solution containing a nonaqueous solvent. Since the quaternary phosphonium salt ionic liquid used in the present invention has a significantly low viscosity, effects such as the improvement of ionic conductivity in an electrolyte or the improvement of permeability of an electrolyte solution into an electrode active material and a separator can be anticipated. Further, because of the high heat resistance and nonflammability of a quaternary phosphonium salt, a highly safe lithium secondary battery can be obtained.

An electrolyte composition comprising the ionic liquid containing the quaternary phosphonium salt represented by the general formula (1) comprises a lithium compound as a supporting electrolyte. The type of such a lithium compound is not particularly limited, as long as it can be dissolved in the quaternary phosphonium salt ionic liquid represented by the general formula (1). Examples of such a lithium compound include LiN(SO₂CF₃)₂, LiN(SO₂F)₂, LiPF₆, LiBF₄, LiB (C₂O₄)₂, LiClO₄, and LiSO₃CF₃. These lithium compounds are preferably used because the conductivity of lithium ion can be increased by the use. These lithium compounds may be used singly, or they may also be used in combination of two or more types. In particular, if two or more types of lithium compounds are used in combination, electric conductivity tends to increase. Thus, the combined use of two or more types of lithium compounds is preferable. Such lithium compounds are mixed into an electrolyte composition at a ratio of preferably 0.5 to 2.0 mole/L, and more preferably 0.8 to 1.5 mole/L, with respect to the quaternary phosphonium salt ionic liquid used as a solvent.

In order to increase charge-discharge characteristics, various types of additives as described below can be added, as necessary, to an electrolyte composition comprising the quaternary phosphonium salt ionic liquid represented by the general formula (1): vinylene carbonate, N-methyl-2-pyrrolidinone, propylene carbonate, ethylene carbonate, butylene carbonate, dimethyl carbonate, ethyl methyl carbonate, diethyl carbonate, γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, a phosphate triester, trialkylphosphine, trimethoxymethane, a dioxolane derivative, sulfolane, methylsulfolane, 3-methyl-2-oxazolidinone, 1,3-dimethyl-2-imidazolidinone, a propylene carbonate derivative, a tetrahydrofuran derivative, a diethyl ether, 1,3-propane sultone, methyl propionate, and ethyl propionate.

The aforementioned additive is added to the quaternary phosphonium salt ionic liquid at preferably 0.2% by volume to 50% by volume, more preferably 1% by volume to 30% by volume, and further more preferably 2% by volume to 20% by volume based on the volume of the quaternary phosphonium salt ionic liquid. By setting the amount of such an additive at 0.2% by volume or more, the cycle characteristics of a lithium secondary battery can be sufficiently improved. Moreover, by setting the amount of such an additive at 50% by volume or less, nonflammability and non-volatility can be maintained, thereby obtaining sufficient safety.

A lithium secondary battery in which the electrolyte composition of the present invention is used comprises a positive electrode, a negative electrode and a separator disposed between the two electrodes. The positive electrode is formed by applying a positive electrode preparation onto a positive electrode charge collector and then drying it, for example. The positive electrode preparation is composed of a positive electrode active material, a conductive agent, a binding agent, a filler that is added if necessary, etc. The negative electrode is formed by applying a negative electrode preparation onto a negative electrode charge collector and then drying it, for example. The negative electrode preparation is composed of a negative electrode active material, a binding agent, a filler that is added if necessary, etc.

The type of a positive electrode active material is not particularly limited, as long as it is a compound capable of insertion and extraction of a lithium ion. Examples of such a positive electrode active material include LiCoO₂, a LiNiₓMn_{y}Co_{1-x-y}O₂ compound, a LiMn₂O₄ compound, a LiFePO₄ compound, a compound formed by substituting the metal element of such compounds with another metal element, and a compound formed by coating the surface of such compounds with an oxide or the like.

The type of a positive electrode charge collector is not particularly limited, as long as it does not cause a chemical change in the constituted battery and it is an electron conductor. Examples of such a positive electrode charge collector include stainless steel, nickel, aluminum, titanium, sintered carbon, and a product formed by treating the surface of aluminum or stainless steel with carbon, nickel, titanium or silver. The surfaces of these materials may be oxidized and used, or a convex-concavo pattern may be established on the surface of a charge collector by a surface treatment and it may be then used. In addition, examples of the form of such a charge collector include a foil, a film, a sheet, a net, a punched form, a glass body, a porous body, a foam, a fiber group, and a nonwoven molded body. The thickness of such a charge collector is not particularly limited. It is preferably 1 to 500 μm, for example.

The type of a conductive agent is not particularly limited, as long as it does not cause a chemical change in the constituted battery and it is an electron conductive material. Examples of such a conductive agent include: graphites such as natural graphite or artificial graphite; carbon blacks such as carbon black, acetylene black, ketjen black, channel black, furnace black, lampblack or thermal black; electrically-conductive fibers such as carbon fiber or metal fiber; metal powders such as carbon fluoride, aluminum or nickel powders; electrically-conductive whiskers such as zinc oxide or potassium titanate; electrically-conductive metal oxides such as titanium oxide; and electrically-conductive materials such as a polyphenylene derivative. Examples of natural graphite include squamous graphite, scale-like graphite and earthy graphite. These graphites can be used singly or in combination of two or more types. Such a conductive agent is mixed into a positive electrode preparation at a mixing ratio of preferably 1% to 50%, and more preferably 2% to 30% based on the weight of the positive electrode preparation.

Examples of a binding agent include starch, polyvinylidene fluoride, polyvinyl alcohol, carboxymethyl cellulose, hydroxypropyl cellulose, regenerated cellulose, diacetyl cellulose, polyvinylpyrrolidone, tetrafluoroethylene, polyethylene, polypropylene, ethylene-propylene-dienta-polymer (EPDM), sulfonated EPDM, styrene-butadiene rubber, fluorocarbon rubber, a tetrafluoroethylene-hexafluoroethylene copolymer, a tetrafluoroethylene-hexafluoropropylene copolymer, a tetrafluoroethylene-perfluoroalkylvinyl ether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinyl ether-tetrafluoroethylene copolymer, an ethylene-acrylic acid copolymer or a (Na+) ion crosslinked form thereof, an ethylene-methacrylic acid copolymer or a (Na+) ion crosslinked form thereof, an ethylene-methyl acrylate copolymer or a (Na+) ion crosslinked form thereof, an ethylene-methyl methacrylate copolymer or a (Na+) ion crosslinked form thereof, polysaccharides such as polyethylene oxide, thermoplastic resin, and a polymer having rubber elasticity. These binding agents can be used singly or in combination of two or more types. When a compound containing a functional group that reacts with lithium, such as polysaccharide, is used, it is desired to add a compound such as an isocyanate group to deactivate the functional group. Such a binding agent is mixed into a positive electrode preparation at a mixing ratio of preferably 1% by weight to 50% by weight, and more preferably 5% by weight to 15% by weight based on the positive electrode preparation.

A filler suppresses the volumetric expansion of a positive electrode in a positive electrode preparation. This agent is added as necessary. The type of a filler is not particularly limited, as long as it does not cause a chemical change in the constituted battery and it is a fibrous material. Examples of such a filler that can be used herein include olefin polymers such as propylene or polyethylene and fibers such as glass or carbon. The additive amount of such a filler is not particularly limited. It is preferably added to a positive electrode preparation at a proportion of 0% by weight to 30% by weight based on the positive electrode preparation.

The type of a negative electrode charge collector is not particularly limited, as long as it does not cause a chemical change in the constituted battery and it is an electron conductor. Examples of such a negative electrode charge collector that can be used herein include copper and a copper alloy. The surfaces of these materials may be oxidized and used, or a convex-concavo pattern may be established on the surface of a charge collector by a surface treatment and it may be then used. Examples of the form of such a charge collector include a foil, a film, a sheet, a net, a punched form, a glass body, a porous body, a foam, a fiber group, and a nonwoven molded body. The thickness of such a charge collector is not particularly limited. It is preferably 1 to 500 μm, for example.

The type of a negative electrode active material is not particularly limited. Examples of such a negative electrode active material include a carbon material, a metal complex oxide, a lithium metal, a lithium alloy, a silicon alloy, a tin alloy, a metal oxide, a conductive polymer, a chalcogen compound, and an Li—Co—Ni material. Examples of a carbon material include a non-graphitizable carbon material and a graphite carbon material. Examples of a metal complex oxide include compounds such as SnₚM¹₁—ₚM²_{q}Oᵣ (wherein M¹ represents one or more types of elements selected from among Mn, Fe, Pb and Ge; M² represents one or more types of elements selected from among Al, B, P, Si, 1 group, 2 group and 3 group of the periodic system, and a halogen element; and 0≦p≦1, 1≦q≦3 and 1≦r≦8), LiₓFe₂O₃ (0≦x≦1), LiₓWO₂ (0≦x≦1), and Li₄Ti₅O₁. Examples of a metal oxide include GeO, GeO₂, SnO, SnO₂, PbO, PbO₂, Pb₂O₃, Pb₃O₄, Sb₂O₃, Sb₂O₄, Sb₂O₅, Bi₂O₃, Bi₂O₄, and Bi₂O₅. Examples of a conductive polymer include polyacetylene and poly-p-phenylene.

As a separator, a thin insulating film having high ionic permeability and predetermined mechanical strength is used. From the viewpoint of organic solvent resistance and hydrophobicity, an olefin polymer such as polypropylene, or a sheet or a nonwoven fabric produced from glass fiber or polyethylene, is used. The pore diameter of such a separator may be within a range that is useful for a general battery, and it is 0.01 to 10 μm, for example. The thickness of such a separator may be within a range that is useful for a general battery, and it is 5 to 300 μm, for example.

An electrolyte composition comprising an ionic liquid containing the quaternary phosphonium salt represented by the general formula (1) can preferably be used as the electrolyte solution of an electric double layer capacitor or a lithium ion capacitor. Since such an electrolyte composition comprising an ionic liquid containing the quaternary phosphonium salt represented by the general formula (1) has an extremely low viscosity, it enables the improvement of low-temperature characteristics and ionic conductivity, and it also enables the improvement of the charge-discharge characteristics of a capacitor.

When such an electrolyte composition comprising an ionic liquid containing the quaternary phosphonium salt represented by the general formula (1) is used as the electrolyte solution of an electric double layer capacitor or a lithium ion capacitor, in order to improve the charge-discharge characteristics of such a capacitor, the electrolyte solution may further comprise an organic solvent, as necessary. Preferred examples of such an organic solvent include acetonitrile, propionitrile, butyronitrile, isobutyronitrile, benzonitrile, dimethoxyethane, tetrahydrofuran, dimethyl carbonate, diethyl carbonate, ethyl methyl carbonate, ethylene carbonate, propylene carbonate, diphenyl carbonate, γ-butyrolactone, and γ-valerolactone. When the aforementioned electrolyte composition is used as the electrolyte solution of a lithium ion capacitor, lithium ion has previously been added to the electrolyte solution.

An electric double layer capacitor or a lithium ion capacitor, in which the electrolyte composition of the present invention is used, comprises a positive electrode and a negative electrode, and it further comprises, as necessary, components commonly used in the technical field of an electric double layer capacitor, such as a separator.

In the case of an electric double layer capacitor, a positive electrode and a negative electrode generally comprise porous carbon such as activated carbon, and also comprise, as necessary, other components such as a conductive agent and a binding agent. The material of activated carbon that can preferably be used for the positive electrode and the negative electrode is not particularly limited. Preferred examples of the material of such activated carbon include heat-resistant resins such as polyimide, polyamide, polyamide imide, polyether imide, polyether sulfone, polyether ketone, bismaleimide triazine, aramid, fluorine resin, polyphenylene, or polyphenylene sulfide. These materials may be used singly, or may also be used in combination of two or more types. From the viewpoint of an increase in the capacitance of a capacitor, the form of activated carbon is preferably a powdery form, a fiber cloth form, etc. In addition, from the viewpoint of an increase in the capacitance of a capacitor, such activated carbon may be subjected to treatments such as a heat treatment, drawing molding, a vacuum high-temperature treatment, or rolling. In the case of a lithium ion capacitor, the same materials as those described in the electric double layer capacitor can be used as positive electrodes. A negative electrode comprises a material capable of absorbing and discharging lithium ion. Examples of such a material include graphite materials such as natural graphite, artificial graphite, hard carbon or soft carbon, materials containing silicon, materials containing tin, materials containing aluminum, and materials containing germanium.

The type of a conductive agent used for the positive electrode and the negative electrode is not particularly limited. Examples of such a conductive agent include graphite and acetylene black. In addition, the type of a binding agent is not particularly limited, either. Examples of such a binding agent include polyvinylidene fluoride (PVDF), polytetrafluoroethylene (PTFE), styrene-butadiene rubber (SBR), and carboxymethyl cellulose (CMC).

The electric double layer capacitor or the lithium ion capacitor, in which the electrolyte composition of the present invention is used, preferably comprise a separator, a charge collector, and the like, as well as the aforementioned positive electrode, negative electrode and electrolyte solution. The type of a separator is not particularly limited. In general, a known separator used as a separator for a nonaqueous electrolyte solution electric double layer capacitor or a lithium ion capacitor is preferably used. Preferred examples of the material of such a separator include a microporous film, a nonwoven fabric, and a paper. Specifically, nonwoven fabrics made from synthetic resins such as polytetrafluoroethylene, polypropylene or polyethylene, and thin-layer films, are preferable. Of these, a microporous film having a thickness of approximately 20 to 50 μm that is made from polypropylene or polyethylene is particularly preferable.

The type of a charge collector is not particularly limited. In general, a known charge collector used as a charge collector for a nonaqueous electrolyte solution electric double layer capacitor or a lithium ion capacitor is preferably used. As such a charge collector, a charge collector excellent in terms of electrochemical corrosion resistance, chemical corrosion resistance, workability and mechanical strength is preferable. For example, a charge collector layer such as aluminum, stainless steel or conductive resin is preferable.

As stated above, an electrolyte composition comprising the quaternary phosphonium salt ionic liquid represented by the general formula (1) has a low viscosity and also has a high withstand voltage property, heat resistance and nonflammability. Accordingly, a lithium secondary battery, an electric double layer capacitor and a lithium ion capacitor, in which the aforementioned electrolyte composition is used, have a high charge-discharge capacity, a high energy density and excellent cycle characteristics, and it also enables the improvement of safety.

### EXAMPLES

The present invention will be specifically described in the following examples. The symbol “%” indicates “% by weight,” unless otherwise specified.

### Synthesis Example 1

### Synthesis of triethyl(methoxymethyl)phosphonium bis(trifluoromethylsulfonyl)imide

62 g (0.5 mol) of bromomethylmethyl ether (a reagent manufactured by Tokyo Chemical Industry Co., Ltd.) was added dropwise to 236 g (0.5 mol) of 25% triethylphosphine solution in toluene (Nippon Chemical Industrial Co., Ltd.; product name: Hishicolin (registered trade mark) P-2), and the mixture was then reacted at 70° C. to 80° C. for 6 hours. After completion of the reaction, hexane was added to the reaction product for crystallization, so as to obtain 97 g of triethyl(methoxymethyl)phosphonium bromide in the form of a crystal (yield: 80%). Thereafter, 86 g (0.3 mol) of lithium bis(trifluoromethylsulfonyl)imide (a reagent manufactured by Kanto Chemical Co., Inc.) was added to 73 g (0.3 mol) of the triethyl(methoxymethyl)phosphonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. The thus obtained product was confirmed by ¹H-NMR, ¹³C-NMR, ³¹P-NMR and ¹⁹F-NMR. The yield amount of the product (colorless transparent liquid) was found to be 104 g (yield: 78%). As a result of the ³¹P-NMR, it was confirmed that the product was triethyl(methoxymethyl)phosphonium bis(trifluoromethylsulfonyl)imide with a purity of 98% or more. It was confirmed by ion chromatography (detection limit: 50 ppm) that the content of halogen was 50 ppm or less. In addition, as a result of the ³¹P-NMR, it was confirmed that triethylphosphine oxide was not detected.

### Synthesis Example 2

### Synthesis of triethyl(2-methoxyethyl)phosphonium bis(trifluoromethylsulfonyl)imide

73 g (0.5 mol) of 2-bromoethylmethyl ether (a reagent manufactured by Tokyo Chemical Industry Co., Ltd.) was added dropwise to 236 g (0.5 mol) of 25% triethylphosphine solution in toluene (Nippon Chemical Industrial Co., Ltd.; product name: Hishicolin (registered trade mark) P-2), and the mixture was then reacted at 70° C. to 80° C. for 6 hours. After completion of the reaction, hexane was added to the reaction product for crystallization, so as to obtain 125 g of triethyl(2-methoxyethyl)phosphonium bromide in the form of a crystal (yield: 97%). Thereafter, 86 g (0.3 mol) of lithium bis(trifluoromethylsulfonyl)imide (a reagent manufactured by Kanto Chemical Co., Inc.) was added to 77 g (0.3 mol) of the triethyl(2-methoxyethyl)phosphonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. The thus obtained product was confirmed in the same manner as described in Synthesis Example 1. The yield amount of the product (colorless transparent liquid) was found to be 126 g (yield: 92%). As a result of the ³¹P-NMR, it was confirmed that the product was triethyl(2-methoxyethyl)phosphonium bis(trifluoromethylsulfonyl)imide with a purity of 98% or more. It was confirmed by ion chromatography (detection limit: 50 ppm) that the content of halogen was 50 ppm or less. In addition, as a result of the ³¹P-NMR, it was confirmed that triethylphosphine oxide was not detected.

### Synthesis Example 3

### Comparison

### Synthesis of triethyl-n-pentylphosphonium bis(trifluoromethylsulfonyl)imide

77 g (0.5 mol) of 1-bromopentane (a reagent manufactured by Tokyo Chemical Industry Co., Ltd.) was added dropwise to 236 g (0.5 mol) of 25% triethylphosphine solution in toluene (Nippon Chemical Industrial Co., Ltd.; product name: Hishicolin (registered trade mark) P-2), and the mixture was then reacted at 70° C. to 80° C. for 5 hours. After completion of the reaction, hexane was added to the reaction product for crystallization, so as to obtain 122 g of triethyl-n-pentylphosphonium bromide in the form of a crystal (yield: 91%). Thereafter, 86 g (0.3 mol) of lithium bis(trifluoromethylsulfonyl)imide (a reagent manufactured by Kanto Chemical Co., Inc.) was added to 81 g (0.3 mol) of the triethyl-n-pentylphosphonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. The thus obtained product was confirmed in the same manner as described in Synthesis Example 1. The yield amount of the product (colorless transparent liquid) was found to be 125 g (yield: 89%). As a result of the ³¹P-NMR, it was confirmed that the product was triethyl-n-pentylphosphonium bis(trifluoromethylsulfonyl)imide with a purity of 98% or more. It was confirmed by ion chromatography (detection limit: 50 ppm) that the content of halogen was 50 ppm or less. In addition, as a result of the ³¹P-NMR, it was confirmed that triethylphosphine oxide was not detected.

### Synthesis Example 4

### Comparison

### Synthesis of triethyl(methoxymethyl)ammonium bis(trifluoromethylsulfonyl)imide

77 g (0.6 mol) of bromomethylmethyl ether (a reagent manufactured by Tokyo Chemical Industry Co., Ltd.) was added dropwise to 51 g (0.5 mol) of triethylamine (a reagent manufactured by Tokyo Chemical Industry Co., Ltd.), and the mixture was then reacted at 60° C. to 70° C. for 6 hours. After completion of the reaction, hexane was added to the reaction product for crystallization, so as to obtain 96 g of triethyl(methoxymethyl)ammonium bromide in the form of a crystal (yield: 85%). Thereafter, 52 g (0.18 mol) of lithium bis(trifluoromethylsulfonyl)imide (a reagent manufactured by Kanto Chemical Co., Inc.) was added to 34 g (0.15 mol) of the triethyl(methoxymethyl)ammonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. The thus obtained product was confirmed by ¹H-NMR, ¹³C-NMR, and ¹⁹F-NMR. As a result, it was confirmed that the product was triethyl(methoxymethyl)ammonium bis(trifluoromethylsulfonyl)imide. The yield amount of the product (colorless transparent liquid) was found to be 59 g (yield: 93%). It was confirmed by ion chromatography (detection limit: 50 ppm) that the content of halogen was 70 ppm.

### Synthesis Example 5

### Comparison

### Synthesis of triethyl(2-methoxyethyl)ammonium bis(trifluoromethylsulfonyl)imide

85 g (0.6 mol) of 2-bromoethylmethyl ether (a reagent manufactured by Tokyo Chemical Industry Co., Ltd.) was added dropwise to 51 g (0.5 mol) of triethylamine (a reagent manufactured by Tokyo Chemical Industry Co., Ltd.), and the mixture was then reacted at 60° C. to 70° C. for 24 hours. After completion of the reaction, hexane was added to the reaction product for crystallization, so as to obtain 64 g of triethyl(2-methoxyethyl)ammonium bromide in the form of a crystal (yield: 53%). Thereafter, 52 g (0.18 mol) of lithium bis(trifluoromethylsulfonyl)imide (a reagent manufactured by Kanto Chemical Co., Inc.) was added to 36 g (0.15 mol) of the triethyl(2-methoxyethyl)ammonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. The thus obtained product was confirmed in the same manner as described in Synthesis Example 4. As a result, it was confirmed that the product was triethyl(2-methoxyethyl)ammonium bis(trifluoromethylsulfonyl)imide. The yield amount of the product (colorless transparent liquid) was found to be 60 g (yield: 91%). It was confirmed by ion chromatography (detection limit: 50 ppm) that the content of halogen was 100 ppm.

### Synthesis Example 6

### Comparison

### Synthesis of tri-n-butyl(2-methoxyethyl)phosphonium bis(trifluoromethylsulfonyl)imide

73 g (0.5 mol) of 2-bromoethylmethyl ether (a reagent manufactured by Tokyo Chemical Industry Co., Ltd.) was added dropwise to 106 g (0.5 mol) of tri-n-butylphosphine (Nippon Chemical Industrial Co., Ltd.; product name: Hishicolin (registered trade mark) P-4), and the mixture was then reacted at 70° C. to 80° C. for 6 hours. After completion of the reaction, hexane was added to the reaction product for crystallization, so as to obtain 155 g of tri-n-butyl(2-methoxyethyl)phosphonium bromide in the form of a crystal (yield: 91%). Thereafter, 86 g (0.3 mol) of lithium bis(trifluoromethylsulfonyl)imide (a reagent manufactured by Kanto Chemical Co., Inc.) was added to 102 g (0.3 mol) of the tri-n-butyl(2-methoxyethyl)phosphonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. The thus obtained product was confirmed in the same manner as described in Synthesis Example 1. The yield amount of the product (colorless transparent liquid) was found to be 153 g (yield: 94%). As a result of the ³¹P-NMR, it was confirmed that the product was tri-n-butyl(2-methoxyethyl)phosphonium bis(trifluoromethylsulfonyl)imide with a purity of 97%. By ion chromatography (detection limit: 50 ppm), the content of halogen was found to be 650 ppm. In addition, as a result of the ³¹P-NMR, it was found that 2% tributylphosphine oxide remained.

### Synthesis Example 7

### Comparison

### Synthesis of tri-n-butyl(methoxymethyl)phosphonium bis(trifluoromethylsulfonyl)imide

62 g (0.5 mol) of bromomethylmethyl ether (a reagent manufactured by Tokyo Chemical Industry Co., Ltd.) was added dropwise to 106 g (0.5 mol) of tri-n-butylphosphine (Nippon Chemical Industrial Co., Ltd.; product name: Hishicolin (registered trade mark) P-4), and the mixture was then reacted at 70° C. to 80° C. for 6 hours. After completion of the reaction, hexane was added to the reaction product for crystallization, so as to obtain 150 g of tri-n-butyl(methoxymethyl)phosphonium bromide in the form of a crystal (yield: 92%). Thereafter, 86 g (0.3 mol) of lithium bis(trifluoromethylsulfonyl)imide (a reagent manufactured by Kanto Chemical Co., Inc.) was added to 98 g (0.3 mol) of the tri-n-butyl(methoxymethyl)phosphonium bromide, and the mixture was then reacted in a water system. Subsequently, the reaction product was stirred at room temperature for 3 hours for maturation. After completion of the stirring, the lower layer (generated product) was separated. The separated product was washed with pure water 4 times, and was then washed with hexane 4 times. After completion of the washing, the resultant was subjected to vacuum drying at 100° C. at a degree of vacuum of 0.5 kPa for 5 hours. After completion of the drying, the resultant was consolidated at room temperature. The thus obtained product was confirmed in the same manner as described in Synthesis Example 1. As a result, it was confirmed that the product was tri-n-butyl(methoxymethyl)phosphonium bis(trifluoromethylsulfonyl)imide. The yield amount of the product (white solid) was found to be 140 g (yield: 88%). As a result of the ³¹P-NMR, it was confirmed that the purity of the product was 97%. By ion chromatography (detection limit: 50 ppm), the content of halogen was found to be 100 ppm.

### Synthesis Example 8

### Comparison

### Synthesis of triethyl(2-methoxyethyl)phosphonium tetrafluoroborate

73 g (0.5 mol) of 2-bromoethylmethyl ether (a reagent manufactured by Tokyo Chemical Industry Co., Ltd.) was added dropwise to 236 g (0.5 mol) of 25% triethylphosphine solution in toluene (Nippon Chemical Industrial Co., Ltd.; product name: Hishicolin (registered trade mark) P-2), and the mixture was then reacted at 70° C. to 80° C. for 6 hours. After completion of the reaction, hexane was added to the reaction product for crystallization, so as to obtain 125 g of triethyl(2-methoxyethyl)phosphonium bromide in the form of a crystal (yield: 97%). Thereafter, 33 g (0.3 mol) of sodium fluoroborate (a reagent manufactured by Kanto Chemical Co., Inc.) was added to 77 g (0.3 mol) of the triethyl(2-methoxyethyl)phosphonium bromide, and the mixture was then reacted in a water system. Subsequently, the reaction product was stirred at room temperature for 3 hours for maturation. After completion of the stirring, the resultant was completely dehydrated at 100° C. at a degree of vacuum of 0.5 kPa. Thereafter, 100 ml of dry methylene chloride was added to the resultant, and a precipitate was then filtrated. The filtrate was concentrated, and it was then subjected to vacuum drying at 100° C. at a degree of vacuum of 0.5 kPa for 5 hours. The thus obtained product was confirmed by ¹H-NMR, ¹³C-NMR, ³¹P-NMR and ¹⁹F-NMR. As a result, it was confirmed that the product was triethyl(2-methoxyethyl)phosphonium tetrafluoroborate. The yield amount of the product (colorless transparent liquid) was found to be 60 g (yield: 76%). As a result of the ³¹P-NMR, it was confirmed that the purity of the product was 98% or more.

[Measurement of Physical Properties]

In terms of physical properties, the ionic liquids synthesized in Synthesis Examples 1-8 were measured by the following methods. The melting point was measured using a differential scanning calorimeter (Seiko Instrumental Inc., DSC6200). The viscosity was measured using a shaking viscometer (CBC Co., Ltd., VM-10A). It is to be noted that such a viscosity includes an error of approximately ±5%, depending on measurement conditions. The conductivity was measured by the alternating-current impedance method (IviumTechnology, Compactstat). The pyrolysis temperature (10% weight reduction) was measured using a thermogravimetric device (Seiko Instrumental Inc., TG/DTA6300). The measurement results are shown in the following Table 1. The aforementioned measurements were all carried out in a dry nitrogen or dry argon atmosphere.

TABLE 1

| | Melting | | | Pyrolysis |
|---|---|---|---|---|
| | point | Viscosity | Conductivity | temperature |
| | (° C.) | (mPa · sec) | (mS/cm) | (° C.) |
| Synthesis | 14 | 35(25° C.) | 4.40(25° C.) | 388 |
| Example 1 | | | | |
| Synthesis | 10 | 44(25° C.) | 3.58(25° C.) | 404 |
| Example 2 | | | | |
| Synthesis | 17 | 88(25° C.) | 1.73(25° C.) | 380 |
| Example 3 | | | | |
| (comparison) | | | | |
| Synthesis | −3 | 69(25° C.) | 3.00(25° C.) | 287 |
| Example 4 | | | | |
| (comparison) | | | | |
| Synthesis | <−50 | 85(25° C.) | 2.16(25° C.) | 384 |
| Example 5 | | | | |
| (comparison) | | | | |
| Synthesis | 12 | 105(25° C.) | 0.86(25° C.) | 391 |
| Example 6 | | | | |
| (comparison) | | | | |
| Synthesis | 27 | —*1 | —*1 | 377 |
| Example 7 | | | | |
| (comparison) | | | | |
| Synthesis | 16 | 194(25° C.) | 2.0(25° C.) | 300 |
| Example 8 | | | | |
| (comparison) | | | | |

*1Unmeasurable due to crystallization

As is clear from the results as shown in Table 1, the ionic liquids of Synthesis Examples 1 and 2 had a lower viscosity, higher conductivity and higher heat resistance than those of the ionic liquids of Synthesis Examples 3 to 8 (comparisons). In addition, it is also found that the content of halogen of each of the ionic liquids of Synthesis Examples 1 and 2 is low.

### Example 1

Lithium bis(trifluoromethylsulfonyl)imide (Kishida Chemical Co., Ltd.) was dissolved in the ionic liquid synthesized in Synthesis Example 1, resulting in a concentration of 1.0 mol/L, so as to prepare an electrolyte composition A. The viscosity at 25° C. and conductivity of the obtained electrolyte composition A are shown in Table 2 below.

### Example 2 and Comparative Examples 1 to 4

Electrolyte compositions B to F were prepared in the same manner as described in Example 1 with the exception that the ionic liquid synthesized in each synthesis example was used instead of the ionic liquid synthesized in Synthesis Example 1. The viscosity at 25° C. and conductivity of each of the obtained electrolyte compositions are shown in Table 2 below.

TABLE 2

| | | Viscosity | Conductivity |
|---|---|---|---|
| | Ionic liquid | (mPa · sec) | (mS/cm) |
| Example 1 | Synthesis | 144(25° C.) | 1.11(25° C.) |
| (composition | Example 1 | | |
| A) | | | |
| Example 2 | Synthesis | 189(25° C.) | 0.78(25° C.) |
| (composition | Example 2 | | |
| B) | | | |
| Comparative | Synthesis | 379(25° C.) | 0.36(25° C.) |
| Example 1 | Example 3 | | |
| (composition | (comparison) | | |
| C) | | | |
| Comparative | Synthesis | 311(25° C.) | 0.58(25° C.) |
| Example 2 | Example 4 | | |
| (composition | (comparison) | | |
| D) | | | |
| Comparative | Synthesis | 345(25° C.) | 0.47(25° C.) |
| Example 3 | Example 5 | | |
| (composition | (comparison) | | |
| E) | | | |
| Comparative | Synthesis | 459(25° C.) | 0.16(25° C.) |
| Example 4 | Example 6 | | |
| (composition | (comparison) | | |
| F) | | | |

As is clear from the comparison of Examples 1 and 2 with Comparative Examples 2 and 3, electrolyte compositions comprising quaternary phosphonium salt ionic liquids (the products of the present invention) have a lower viscosity and higher conductivity than those of electrolyte compositions comprising quaternary ammonium salt ionic liquids (comparative products). Thus, it is found that the products of the present invention can preferably be used as electrolytes of lithium secondary batteries. Moreover, as is clear from the comparison of Examples 1 and 2 with Comparative Example 1, electrolyte compositions comprising a quaternary phosphonium salt ionic liquid having an alkoxyalkyl group (the products of the present invention) have a lower viscosity and higher conductivity than those of an electrolyte composition comprising a quaternary phosphonium salt ionic liquid that does not have an alkoxyalkyl group (a comparative product). Furthermore, as is clear from the comparison of Example 2 with Comparative Example 4, an electrolyte composition comprising a quaternary phosphonium salt ionic liquid having an alkyl group containing 2 carbon atoms (the product of the present invention) has a lower viscosity and higher conductivity than those of an electrolyte composition comprising a quaternary phosphonium salt ionic liquid having an alkyl group containing 3 carbon atoms (a comparative product).

### Example 3

Using a burner, a direct fire was allowed to come into contact with a sample formed by impregnating a glass fiber sheet (width: 3 cm; length: 5 cm; thickness: 3 mm) with 5 g of electrolyte composition A for 10 seconds, so as to burn it. Thereafter, the time required until the fire was extinguished was measured. The results are shown in Table 3.

### Examples 4 and Comparative Examples 5 to 8

A combustion test was carried out in the same manner as described in Example 3 with the exception that the electrolyte compositions prepared in Example 2 and Comparative Examples 1 to 4 were used instead of the electrolyte composition A. The results are shown in Table 3.

TABLE 3

| | | Time required |
|---|---|---|
| | Electrolyte | until fire |
| | composition | extinction |
| Example 3 | A | Not ignited |
| Example 4 | B | Not ignited |
| Comparative | C | 20 sec |
| Example 5 | | |
| Comparative | D | 120 sec |
| Example 6 | | |
| Comparative | E | 130 sec |
| Example 7 | | |
| Comparative | F | 30 sec |
| Example 8 | | |

As is apparent from the results as shown in Table 3, the electrolyte composition of each example has higher nonflammability than that of the electrolyte composition of each comparative example.

### Example 5

Using the electrolyte composition A prepared in Example 1 as an electrolyte solution, a lithium secondary battery was produced by the following procedures.

Lithium cobaltate (manufactured by Nippon Chemical Industrial Co., Ltd., Cellseed (registered trade mark) C-5) was used as a positive electrode active material. 95% of the positive electrode active material, 2.5% of carbon powders (manufactured by TIMCAL, SUPER P) and 2.5% of polyvinylidene fluoride were mixed to produce a positive electrode preparation. This positive electrode preparation was dispersed in N-methyl-2-pyrrolidinone, so as to prepare a mixed paste. The mixed paste was applied to aluminum foil, and it was then dried and compressed. Thereafter, a disk with a diameter of 15 mm was punched out, so as to obtain a positive electrode board. This positive electrode board (the weight of the positive electrode material: 7 mg), a separator consisting of a nonwoven fabric made from a synthetic resin, a negative electrode consisting of metallic lithium, a mounting hardware, an external terminal, etc. were used to produce a lithium secondary battery.

With regard to the produced lithium secondary battery, the positive electrode was charged at a rate of 0.1 mA/cm² at room temperature (25° C.) until the voltage thereof became 4.2 V. Thereafter, it was discharged at a rate of 0.1 mA/cm² until the voltage thereof became 3.4 V. Such a charge-discharge operation was carried out for 1 cycle. The initial discharged capacity (mAh/g) and the initial energy density (mWh/g) were measured. Subsequently, such a charge-discharge operation performed during the aforementioned measurement of a discharged capacity was carried out for 20 cycles. A capacity maintenance rate and an energy maintenance rate were calculated by the following formulae. The results are shown in Table 4.

Capacity maintenance rate (%)=(discharged capacity at 20^{th} cycle/discharged capacity at 1^{st} cycle)×100

Energy maintenance rate (%)=(discharged energy density at 20^{th} cycle/discharged energy density at 1^{st} cycle)×100

### Example 6 and Comparative Examples 9 to 12

Lithium secondary batteries were produced in the same manner as described in Example 5 with the exception that the electrolyte compositions prepared in Example 2 and Comparative Examples 1 to 3 were used instead of the electrolyte composition A. The capacity maintenance rate and energy maintenance rate of each of the produced lithium secondary batteries were calculated. The results are shown in Table 4.

TABLE 4

| | | | | Capacity | Energy |
|---|---|---|---|---|---|
| | | | Initial | main- | main- |
| | | Initial | discharged | tenance | tenance |
| | Electrolyte | discharged | energy | rate after | rate after |
| | composi- | capacity | density | 20 cycles | 20 cycles |
| | tion | (mAh/g) | (mWh/g) | (%) | (%) |
| Example 5 | A | 149.2 | 546.6 | 91.3 | 90.6 |
| Example 6 | B | 147.3 | 547.0 | 93.6 | 92.8 |
| Comparative | C | 145.0 | 529.7 | 69.8 | 69.6 |
| Example 9 | | | | | |
| Comparative | D | 144.2 | 531.7 | 60.5 | 60.0 |
| Example 10 | | | | | |
| Comparative | E | 136.5 | 468.3 | 41.2 | 41.2 |
| Example 11 | | | | | |
| Comparative | F | 126.2 | 442.4 | 77.4 | 74.8 |
| Example 12 | | | | | |

As is apparent from the results as shown in Table 4, the lithium secondary battery of each example has an initial discharged capacity and an initial energy density that are higher than those of the secondary battery of each comparative example. Moreover, it is found that the lithium secondary battery of each example is also excellent in terms of a capacity maintenance rate and an energy maintenance rate obtained after 20 cycles.

What is claimed is:

1. An electrolyte composition used in a charge storage device, which comprises a quaternary phosphonium salt ionic liquid represented by the following general formula (1): 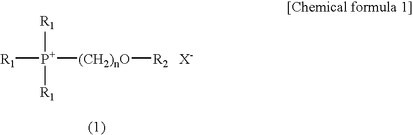
wherein R₁ represents a linear or branched alkyl group containing 1 to 3 carbon atoms; R₂ represents a methyl group or an ethyl group; n represents an integer between 1 and 3; and X represents N(SO₂CF₃)₂.

2. The electrolyte composition used in a charge storage device according to claim 1, which has a viscosity at 25° C. of 200 mPa·sec or less.

3. The electrolyte composition used in a charge storage device according to claim 1, wherein R₁ is an ethyl group and n is 2.

4. The electrolyte composition used in a charge storage device according to claim 1, wherein the content of halogen is 100 ppm or less.

5. A charge storage device, comprising an electrolyte composition including a quaternary phosphonium salt ionic liquid represented by the following general formula (1): 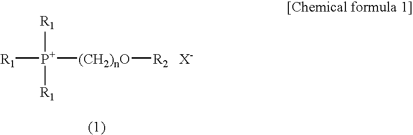
wherein R₁ represents a linear or branched alkyl group containing 1 to 3 carbon atoms; R₂ represents a methyl group or an ethyl group; n represents an integer between 1 and 3; and X represents N(SO₂CF₃)₂.

6. The charge storage device according to claim 5, wherein the charge storage device is a lithium secondary battery, an electric double layer capacitor, or a lithium ion capacitor.
